(19) United States
(12) Patent Application Publication
(10) Pub. No.: US 2017/0195482 A1
(43) Pub. Date: Jul. 6, 2017

(54) Processing Method and Processing Device for Communication Information of Terminal and Terminal

(71) Applicant: Yulong Computer Telecommunication Scientific (Shenzhen) Co., Ltd., Shenzhen (CN)

(72) Inventor: Lun Yang, Dongguan (CN)

(21) Appl. No.: 15/458,633

(22) Filed: Mar. 14, 2017

Related U.S. Application Data
(63) Continuation-in-part of application No. PCT/CN2014/096012, filed on Dec. 31, 2014.

(30) Foreign Application Priority Data
Nov. 21, 2014 (CN) 201410682631.6

(51) Int. Cl. H04M 3/42

(52) U.S. Cl. CPC H04M 3/42059; H04W 88/06

(57) ABSTRACT

A processing method for communication information of a terminal, a processing device for communication information of a terminal, and a terminal are provided. The terminal includes a first system and a second system. The processing method for communication information includes: acquiring information of an initiator of communication information when the communication information is received; and processing the communication information in the first system or the second system according to attribute information of the information of the initiator.

### CROSS-REFERENCE TO RELATED APPLICATION(S)

This application is a continuation-in-part of International Patent Application PCT No. PCT/CN2014/096012, filed on Dec. 31, 2014, which claims priority to Chinese Patent Application No. 201410682631.6, filed on Nov. 21, 2014, the contents of both of which are hereby incorporated by reference in their entireties.

### TECHNICAL FIELD

The present disclosure relates to terminal technical field, and in particular, to a processing method for communication information of a terminal, a processing device for communication information of a terminal, and a terminal.

### BACKGROUND

For a smart terminal having dual systems, when an incoming call is received, the incoming call is often directly answered in a currently running system of the smart terminal. That is, when the smart terminal receives communication information, which system is used to process the communication information is often random.

For example, which system is used to process communication information often cannot be set by users, accordingly user experience is affected. Communication information from some important contacts may be directly processed in a normal system, which may cause leakage of the communication information.

### SUMMARY

Based on at least one of the technical problem of the present disclosure, a new processing method for communication information of a terminal is provided. On one hand, a user can independently set a system for processing communication information, thus operation experience of the user can be improved. On the other hand, communication information from important contacts can be set to be processed in a safe system, which can avoid leakage of the communication information from the important contacts, and can effectively ensure safety of the communication information from the important contacts.

In view of this, in the present disclosure, a processing method for communication information of a terminal is provided. The terminal includes a first system and a second system. The processing method for communication information includes: acquiring information of an initiator of communication information when the communication information is received, and processing the communication information in the first system or the second system according to attribute information of the information of the initiator.

In the technical solution, the first system can be a normal system, and the second system can be a safe system. The system for processing the communication information is selected according to the attribute information of the information of the initiator. On one hand, a corresponding system can be selected to process communication information from some initiators according to the attribute information set by a user. For example, communication information from some initiators are set to be processed in a specified system, which can ensure that the user can independently set a system for processing communication information, thus operation experience of the user can be improved. On the other hand, communication information from important contacts can be set to be processed in the safe system, which can avoid leakage of the communication information from the important contacts, and effectively ensure safety of the communication information from the important contacts.

Wherein, the information of the initiator can be contact information of the initiator (for example, a telephone number, a mail address, and so on), an identifier of the initiator (for example, a name of the initiator), and so on.

Communication information may include voice communication information and text communication information. The voice communication information may be voice call information, voice call information of third-party applications (for example, instant message or social network applications), and so on. The text communication information may be message information, mail information, text messages of the third-part applications, and so on.

Processing the voice communication information includes answering the voice call, and so on. Processing the text communication information includes viewing the text communication information, editing the text communication information, forwarding the text communication information, and so on.

According to an implementation of the present disclosure, processing the communication information in the first system or the second system according to the attribute information of the information of the initiator includes: determining whether an address book of the terminal includes the information of the initiator; and processing the communication information in the first system when it is determined that the address book of the terminal does not include the information of the initiator.

In the technical solution of the implementation, the attribute information of the information of the initiator can be that whether the initiator is a contact person of the address book of the terminal. When the initiator is not a contact person of the address book of the terminal, the communication information is directly processed in the first system (e.g., the normal system).

Additionally, when the initiator is a contact person of the address book of the terminal, on one hand, following processing can be executed, that is, when it is determined that the address book of the terminal includes the information of the initiator, the communication information is processed in the second system. Meanwhile, a system related to the information of the initiator can be further determined, so as to cause the system related to the information of the initiator to process the communication information. Specifically, when it is determined that the system related to the information of the initiator is the first system, or when it is determined that the information of the initiator is not related to any system, the communication information is processed in the first system. When it is determined that the system related to the information of the initiator is the second system, the communication information is processed in the second system.

According to another implementation of the present disclosure, processing the communication information in the first system or the second system according to the attribute information of the information of the initiator includes: determining a system related to the information of the initiator according to the attribute information of the information of the initiator; processing the communication information in the first system when it is determined that the system related to the information of the initiator is the first system, or when it is determined that the information of the initiator is not related to any system; and processing the communication information in the second system when it is determined that the system related to the information of the initiator is the second system.

In the technical solution of the present disclosure, whether the initiator of the communication information is a contact person of the address book of the terminal is not determined, and the communication system is directly processed in the system related to the information of the initiator. Specifically, for example, an identifier for setting related initiators can be displayed on a setting interface of the terminal system. The user can set related initiators by loading the address book, and can also set related initiators by directly inputting contact information of the initiators.

In the above technical solution, preferably, the method further includes: processing the communication information directly when it is determined that the communication information is to be processed in the first system; and encrypting the communication information when it is determined that the communication information is to be processed in the second system, so as to avoid leakage of the communication information.

In the technical solution, the communication information is encrypted when the communication information is processed in the second system (for example, the safe system), which can avoid leakage of the communication information, and can effectively ensure safety of user information. Encrypting the communication information may include encrypting the text communication information, for example, hiding sensitive content of the text communication information, or replacing the sensitive content of the text communication information with other content, and performing anti-eavesdrop process on the voice communication information.

According to an implementation of a second aspect of the present disclosure, a processing device for communication information of a terminal is further provided. The terminal includes a first system and a second system. The processing device for communication information of the terminal includes a receiving unit configured to receive communication information, an acquiring unit configured to acquire information of an initiator of the communication information when the receiving unit receives the communication information, and a processing unit configured to process the communication information in the first system or the second system according to attribute information of the information of the initiator.

In the technical solution, the first system can be a normal system, and the second system can be a safe system. The system for processing the communication information is selected according to the attribute information of the information of the initiator. On one hand, a corresponding system can be selected to process communication information from some initiators according to the attribute information set by a user. For example, communication information from some initiators are set to be processed in a specified system, which can ensure that the user can independently set a system for processing communication information, thus operation experience of the user can be improved. On the other hand, communication information from important contacts can be set to be processed in the safe system, which can avoid leakage of the communication information from the important contacts, and effectively ensure safety of the communication information from the important contacts. The information of the initiator can be contact information of the initiator (for example, a telephone number, a mail address, and so on), an identifier of the initiator (for example, a name of the initiator), and so on.

Communication information may include voice communication information and text communication information. The voice communication information may be voice call information, voice call information of third-party applications (for example, instant message or social network applications), and so on. The text communication information may be message information, mail information, text messages of the third-part applications, and so on.

Processing the voice communication information includes answering the voice call, and so on. Processing the text communication information includes viewing the text communication information, editing the text communication information, forwarding the text communication information, and so on.

According to an implementation of the present disclosure, the processing unit includes a judging unit configured to judging whether an address book of the terminal includes the information of the initiator, and a first executing unit configured to process the communication information in the first system when the judging unit determines that the address book of the terminal does not include the information of the initiator.

In the technical solution of the implementation, the attribute information of the information of the initiator can be that whether the initiator is a contact person of the address book of the terminal. When the initiator is not a contact person of the address book of the terminal, the communication information is directly processed in the first system (e.g., the normal system).

Additionally, when the initiator is a contact person of the address book of the terminal, on one hand, following processing can be executed, that is, the first executing unit is further configured to process the communication information in the second system when the judging unit determines that the address book of the terminal includes the information of the initiator. On the other hand, a system related to the information of the initiator can be further determined, so as to cause the system related to the information of the initiator to process the communication information. Specifically, when it is determined that the system related to the information of the initiator is the first system, or when it is determined that the information of the initiator is not related to any system, the communication information is processed in the first system. When it is determined that the system related to the information of the initiator is the second system, the communication information is processed in the second system.

According to another implementation of the present disclosure, the processing unit includes a determining unit configured to determine a system related to the information of the initiator according to the attribute information of the information of the initiator, and a second executing unit configured to process the communication information in the first system when the determining unit determines that the system related to the information of the initiator is the first system, or determines that the information of the initiator is not related to any system, and process the communication information in the second system when the determining unit determines that the system related to the information of the initiator is the second system.

In the technical solution of the present disclosure, whether the initiator of the communication information is a contact person of the address book of the terminal is not determined, and the communication system is directly processed in the system related to the information of the initiator. Specifically, for example, an identifier for setting related initiators can be displayed on a setting interface of the terminal system. The user can set related initiators by loading the address book, and can also set related initiators by directly inputting contact information of the initiators.

In the above technical solution, preferably, the processing unit is configured to process the communication information directly when it is determined that the communication information is to be processed in the first system; and encrypting the communication information when it is determined that the communication information is to be processed in the second system, so as to avoid leakage of the communication information.

In the technical solution, the communication information is encrypted when the communication information is processed in the second system (for example, the safe system), which can avoid leakage of the communication information, and can effectively ensure safety of user information. Encrypting the communication information may include encrypting the text communication information, for example, hiding sensitive content of the text communication information, or replacing the sensitive content of the text communication information with other content, and performing anti-eavesdrop process on the voice communication information.

According to a third aspect of the present disclosure, a terminal is further provided. The terminal includes the processing device for communication information of a terminal of any of the above technical solutions.

By means of the above technical solution, on one hand, a user can independently set a system for processing communication information, thus operation experience of the user can be improved. On the other hand, communication information from important contacts can be set to be processed in the safe system, which can avoid leakage of the communication information from the important contacts, and effectively ensure safety of the communication information from the important contacts.

### BRIEF DESCRIPTION OF THE DRAWINGS

FIG. 1 is a schematic flow chart of a processing method for communication information of a terminal in accordance with an implementation of the present disclosure.

FIG. 2 is a schematic block diagram of a processing device for communication information of a terminal in accordance with an implementation of the present disclosure.

FIG. 3 is a structural view of a processing scheme for communication information in accordance with an implementation of the present disclosure.

FIG. 4 is a schematic flow chart of a processing method for an incoming call in accordance with an implementation of the present disclosure.

FIG. 5 is a schematic flow chart of a processing method for an incoming call in accordance with another implementation of the present disclosure.

FIG. 6 is a schematic flow chart of a processing method for an incoming call in accordance with yet another implementation of the present disclosure.

FIG. 7 is a diagrammatic view of a terminal in accordance with an implementation of the present disclosure.

### DETAILED DESCRIPTION

To understand the above-mentioned purposes, features and advantages of the present disclosure more clearly, the present disclosure will be further described in detail below in combination with the accompanying drawings and the specific implementations. What needs to be illustrated is that, the implementations of the present application and the features in the implementations may be combined with one another without conflicts.

Many specific details will be described below for sufficiently understanding the present disclosure. However, the present disclosure may also be implemented by adopting other manners different from those described herein. Accordingly, the protection scope of the present disclosure is not limited by the specific implementations disclosed below.

In the present disclosure, a terminal includes a first system and a second system. The first system may be a normal system, and the second system may be a safe system.

Communication information may include voice communication information and text communication information. The voice communication information may be voice call information, voice call information of third-party applications (for example, instant message or social network applications), and so on. The text communication information may be message information, mail information, text messages of the third-part applications, and so on.

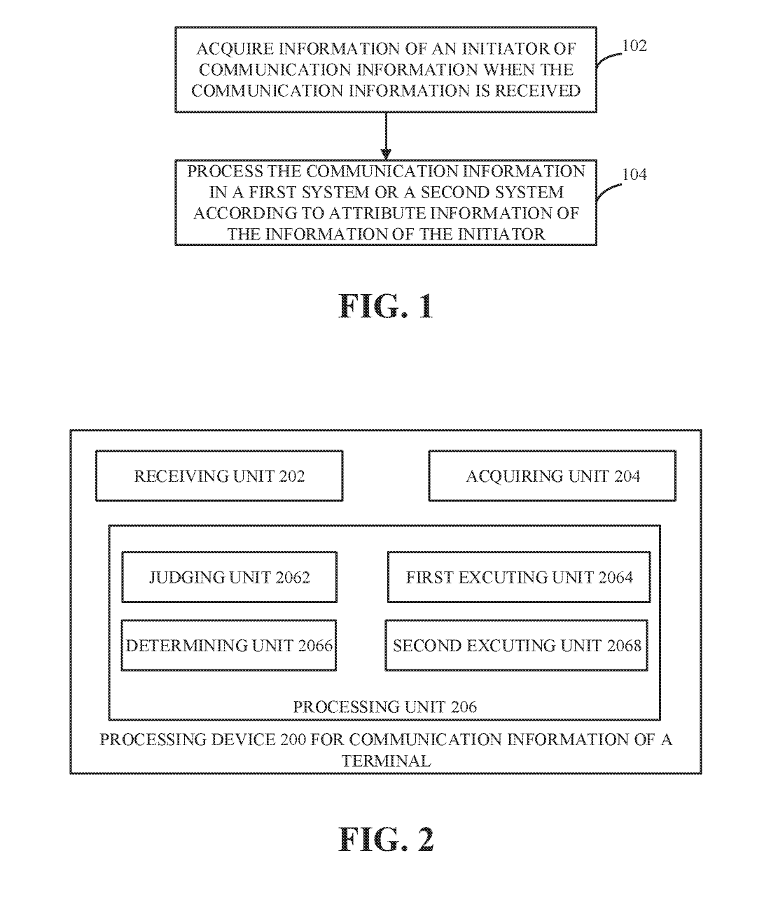

FIG. 1 is a schematic flow chart of a processing method for communication information of the terminal in accordance with an implementation of the present disclosure.

As illustrated by FIG. 1, the processing method for communication information of the terminal in accordance with an implementation of the present disclosure includes: step 102, acquiring information of an initiator of communication information when the communication information is received, and step 104, processing the communication information in the first system or the second system according to attribute information of the information of the initiator.

In the technical solution, the system for processing the communication information is selected according to the attribute information of the information of the initiator. On one hand, a corresponding system can be selected to process communication information from some initiators according to the attribute information set by a user. For example, communication information from some initiators are set to be processed in a specified system, which can ensure that the user can independently set a system for processing communication information, thus operation experience of the user can be improved. On the other hand, communication information from important contacts can be set to be processed in the safe system, which can avoid leakage of the communication information from the important contacts, and effectively ensure safety of the communication information from the important contacts.

The information of the initiator can be contact information of the initiator (for example, a telephone number, a mail address, and so on), an identifier of the initiator (for example, a name of the initiator), and so on. Processing the voice communication information includes answering the voice call, and so on. Processing the text communication information includes viewing the text communication information, editing the text communication information, forwarding the text communication information, and so on.

According to an implementation of the present disclosure, processing the communication information in the first system or the second system according to the attribute information of the information of the initiator includes: determining whether an address book of the terminal includes the information of the initiator; and processing the communication information in the first system when it is determined that the address book of the terminal does not include the information of the initiator.

In the technical solution of the implementation, the attribute information of the information of the initiator can be that whether the initiator is a contact person of the address book of the terminal. When the initiator is not a contact person of the address book of the terminal, the communication information is directly processed in the first system (e.g., the normal system).

Additionally, when the initiator is a contact person of the address book of the terminal, on one hand, following processing can be executed, that is, when it is determined that the address book of the terminal includes the information of the initiator, the communication information is processed in the second system. On the other hand, a system related to the information of the initiator is further determined, so as to cause the system related to the information of the initiator to process the communication information. Specifically, when it is determined that the system related to the information of the initiator is the first system, or when it is determined that the information of the initiator is not related to any system, the communication information is processed in the first system. When it is determined that the system related to the information of the initiator is the second system, the communication information is processed in the second system.

According to another implementation of the present disclosure, processing the communication information in the first system or the second system according to the attribute information of the information of the initiator includes: determining a system related to the information of the initiator according to the attribute information of the information of the initiator; processing the communication information in the first system when it is determined that the system related to the information of the initiator is the first system, or it is determined that the information of the initiator is not related to any system; and processing the communication information in the second system when it is determined that the system related to the information of the initiator is the second system.

In the technical solution of the present disclosure, whether the initiator of the communication information is a contact person of the address book of the terminal is not determined, and the communication system is directly processed in the system related to the information of the initiator. Specifically, for example, an identifier for setting related initiators can be displayed on a setting interface of the terminal system. The user can set related initiators by loading the address book, and can also set related initiators by directly inputting contact information of the initiators.

In the above technical solution, preferably, the method further includes: processing the communication information directly when it is determined that the communication information is to be processed in the first system; and encrypting the communication information when it is determined that the communication information is to be processed in the second system, so as to avoid leakage of the communication information.

In the technical solution, the communication information is encrypted when the communication information is processed in the second system (for example, the safe system), which can avoid leakage of the communication information, and can effectively ensure safety of user information. Encrypting the communication information may include encrypting the text communication information, for example, hiding sensitive content of the text communication information, or replacing the sensitive content of the text communication information with other content, and performing anti-eavesdrop process on the voice communication information.

FIG. 2 is a schematic block diagram of a processing device for communication information of a terminal in accordance with an implementation of the present disclosure.

As illustrated by FIG. 2, the processing device for communication information of the terminal in accordance with an implementation of the present disclosure includes a receiving unit 202 configured to receive communication information, an acquiring unit 204 configured to acquire information of an initiator of the communication information when the receiving unit 202 receives the communication information, and a processing unit 206 configured to process the communication information in the first system or the second system according to attribute information of the information of the initiator.

In the technical solution, the system for processing the communication information is selected according to the attribute information of the information of the initiator. On one hand, a corresponding system can be selected to process communication information from some initiators according to the attribute information set by a user. For example, communication information from some initiators are set to be processed in a specified system, which can ensure that the user can independently set a system for processing communication information, thus operation experience of the user can be improved. On the other hand, communication information from important contacts can be set to be processed in the safe system, which can avoid leakage of the communication information from the important contacts, and effectively ensure safety of the communication information from the important contacts.

The information of the initiator can be contact information of the initiator (for example, a telephone number, a mail address, and so on), an identifier of the initiator (for example, a name of the initiator), and so on. The communication information may include voice communication information and text communication information. The voice communication information may be voice call information, voice call information of third-party applications (for example, instant message or social network applications), and so on. The text communication information may be message information, mail information, text messages of the third-part applications, and so on.

Processing the voice communication information includes answering the voice call, and so on. Processing the text communication information includes viewing the text communication information, editing the text communication information, forwarding the text communication information, and so on.

According to an implementation of the present disclosure, the processing unit 206 includes a judging unit 2062 configured to judge whether an address book of the terminal includes the information of the initiator, and a first executing unit 2064 configured to process the communication information in the first system when the judging unit 2062 determines that the address book of the terminal does not include the information of the initiator.

In the technical solution of the implementation, the attribute information of the information of the initiator can be that whether the initiator is a contact person of the address book of the terminal. When the initiator is not a contact person of the address book of the terminal, the communication information is directly processed in the first system (e.g., the normal system).

Additionally, when the initiator is a contact person of the address book of the terminal, on one hand, following processing can be executed, that is, the first executing unit 2064 is further configured to process the communication information in the second system when the judging unit 2062 determines that the address book of the terminal includes the information of the initiator. On the other hand, a system related to the information of the initiator can be further determined, so as to cause the system related to the information of the initiator to process the communication information. Specifically, when it is determined that the system related to the information of the initiator is the first system, or when it is determined that the information of the initiator is not related to any system, the communication information is processed in the first system. When it is determined that the system related to the information of the initiator is the second system, the communication information is processed in the second system.

According to another implementation of the present disclosure, the processing unit 206 includes a determining unit 2066 configured to determine a system related to the information of the initiator according to the attribute information of the information of the initiator, and a second executing unit 2068 configured to process the communication information in the first system when the determining unit 2066 determines that the system related to the information of the initiator is the first system, or determines that the information of the initiator is not related to any system, and process the communication information in the second system when the determining unit 2066 determines that the system related to the information of the initiator is the second system.

In the technical solution of the present disclosure, whether the initiator of the communication information is a contact person of the address book of the terminal is not determined, and the communication system is directly processed in the system related to the information of the initiator. Specifically, for example, an identifier for setting related initiators can be displayed on a setting interface of the terminal system. The user can set related initiators by loading the address book, and can also set related initiators by directly inputting contact information of the initiators.

In the above technical solution, preferably, the processing unit 206 is configured to process the communication information directly when it is determined that the communication information is to be processed in the first system; and encrypting the communication information when it is determined that the communication information is to be processed in the second system, so as to avoid leakage of the communication information.

In the technical solution, the communication information is encrypted when the communication information is processed in the second system (for example, the safe system), which can avoid leakage of the communication information, and can effectively ensure safety of user information. Encrypting the communication information may include encrypting the text communication information, for example, hiding sensitive content of the text communication information, or replacing the sensitive content of the text communication information with other content, and performing anti-eavesdrop process on the voice communication information.

The present disclosure further provides a terminal (not shown in the accompanying drawings) which includes the processing device 200 for communication information of the terminal illustrated by FIG. 2.

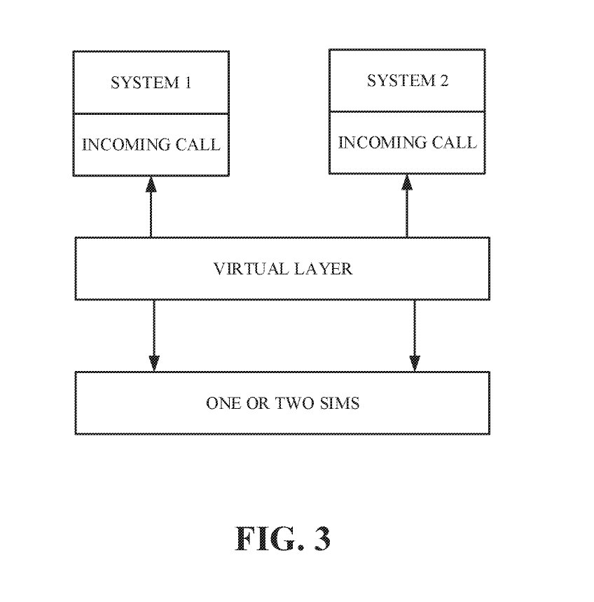

The following will specifically illustrate the technical solution of the present disclosure in combination with FIGS. 3-6, and a terminal which uses a normal system and a safe system to process an incoming call will be taken as an example.

As illustrated by FIG. 3, the terminal in accordance with an implementation of the present disclosure includes a virtual layer. When an incoming call is received, the virtual layer firstly queries a contact database to determine whether the caller identification (ID) is in a contact list of the terminal. If the caller ID is not found, it indicates that the caller ID is a strange caller ID, and the virtual layer controls a system 1 to answer the incoming call. If the caller ID is found, it indicates that the caller ID is in the contact list, and following operations will be executed.

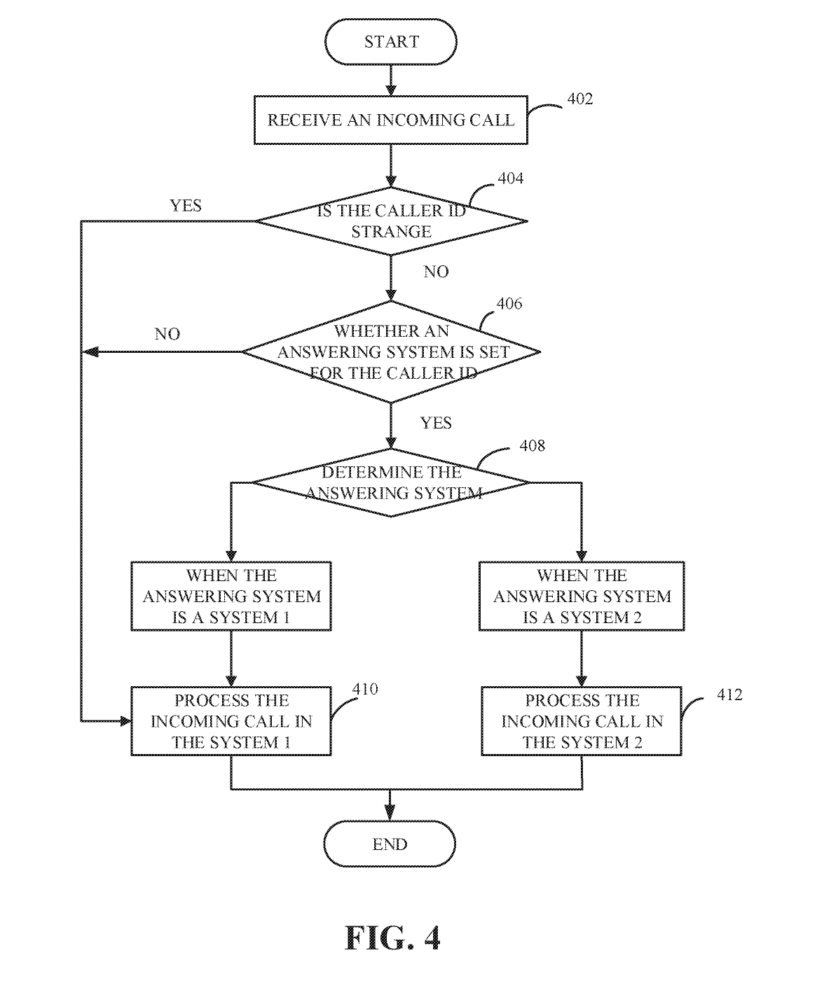

The terminal system determines whether an “answering system” is set for the caller ID. If an “answering system” is not set for the caller ID, the incoming call is answered in the default system, that is, the system 1. If the “answering system” for the caller ID is set to be the system 1, the incoming call is answered in the system 1. If the “answering system” for the caller ID is set to be a system 2, the incoming call is answered in the system 2. Detailed process is illustrated by FIG. 4.

As illustrated by FIG. 4, a processing method for an incoming call in accordance with an implementation of the present disclosure includes following.

Step 402, an incoming call is received.

Step 404, whether the caller ID is a strange caller ID is determined. If yes, step 410 is executed, otherwise, step 406 is executed.

Step 406, when it is determined that the caller ID is not a strange caller ID, whether an “answering system” is set for the caller ID is determined. If yes, step 408 is executed, otherwise, step 410 is executed.

Step 408, when it is determined that an “answering system” is set for the caller ID, the “answering system” is determined. If the “answering system” is set to be the “system 1”, step 410 is executed, and if the “setting system” is set to be the “system 2”, step 412 is executed.

Step 410, the incoming call is processed in the system 1.

Step 412, the incoming call is processed in the system 2.

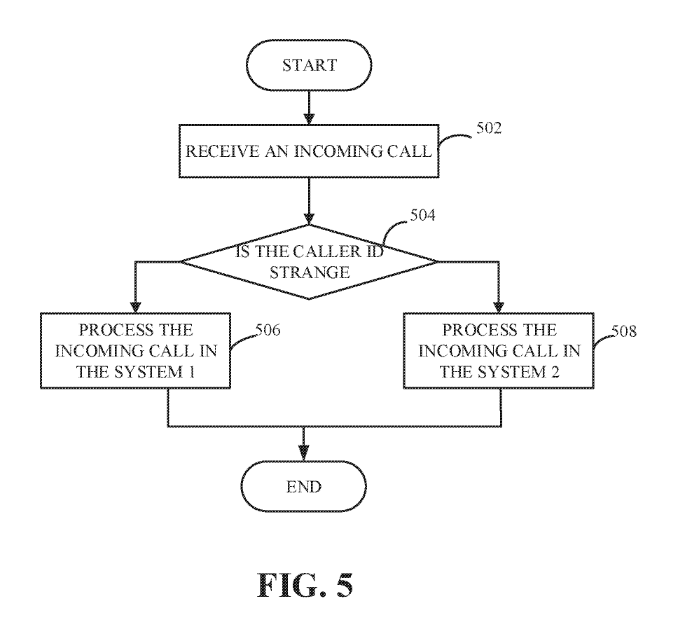

A processing method for an incoming call in accordance with another implementation of the present disclosure is illustrated by FIG. 5.

As illustrated by FIG. 5, the processing method for an incoming call in accordance with another implementation of the present disclosure includes following.

Step 502, an incoming call is received.

Step 504, whether the caller ID is a strange caller ID is determined. If yes, step 506 is executed, otherwise, step 508 is executed.

Step 506, when it is determined that the caller ID is a strange caller ID, the incoming call is processed in the system 1.

Step 508, when it is determined that the caller ID is not a strange caller ID, the incoming call is processed in the system 2.

In the implementation, which system is determined to be used to process the incoming call is determined by determining whether the caller ID is a strange caller ID.

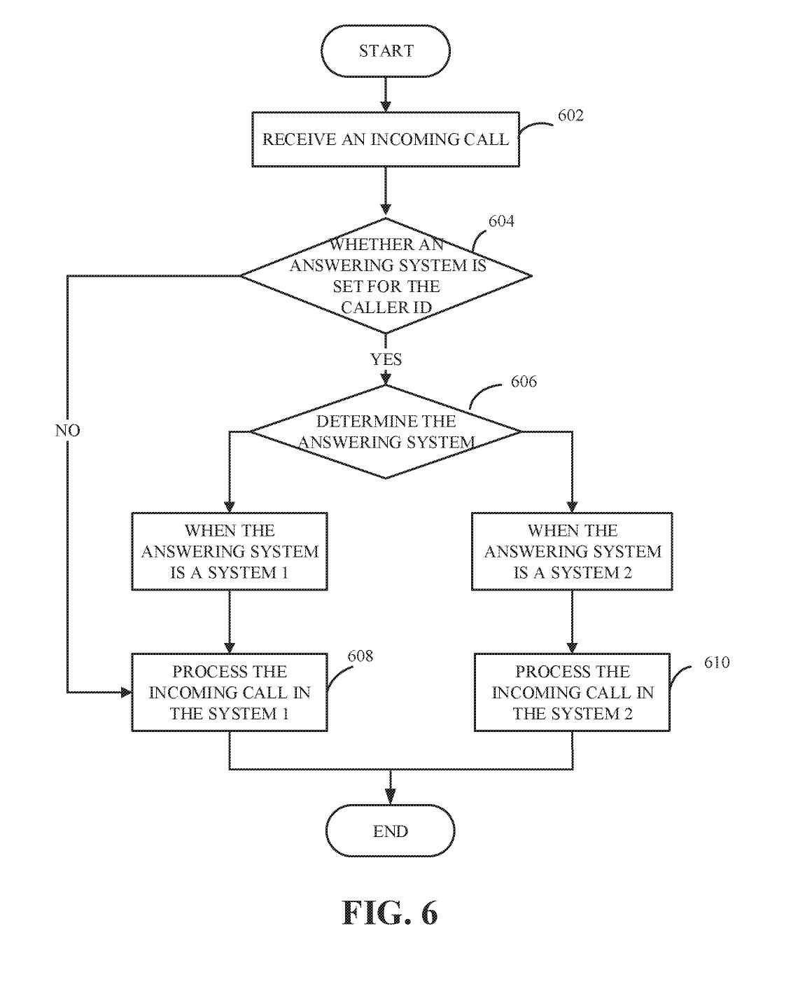

A processing method for an incoming call in accordance with another implementation of the present disclosure can be illustrated by FIG. 6.

As illustrated by FIG. 6, the processing method for an incoming call in accordance with yet another implementation of the present disclosure includes following.

Step 602, an incoming call is received.

Step 604, whether an “answering system” is set for the caller ID is determined. If yes, step 606 is executed, otherwise, step 608 is executed.

Step 606, when it is determined that an “answering system” is set for the caller ID, the “answering system” is determined. When it is determined that the “answering system” is set to be the “system 1”, step 608 is executed. When it is determined that the “answering system” is set to be the “system 2”, step 610 is executed.

Step 608, the incoming call is processed in the system 1.

Step 610, the incoming call is processed in the system 2.

In the implementation, which system is determined to be used to process the incoming call is determined according to the “answering system” for the caller ID.

In an implementation of the present disclosure, an option for setting an “answering system” can be added to a contact editing interface of the terminal system. By means of the option, the user can select a system to answer the incoming call according to user's needs. Specifically, for an incoming call which needs to be kept secret or from an important contact person, a system having a high safe performance can be set to answer the incoming call. For an incoming call from an unimportant contact person or from a strange person, a normal system can be set to answer the incoming call. The processing method for other communication information is similar to the processing method for an incoming call, which will not be repeated herein.

In accordance with another implementation of the present disclosure, a setting option for correlating contact persons with systems can be added to a setting interface of the terminal system. The user can perform operations to correlate contact persons with systems by downloading the address book, and can also perform operations to correlate contact persons with systems by inputting telephone numbers.

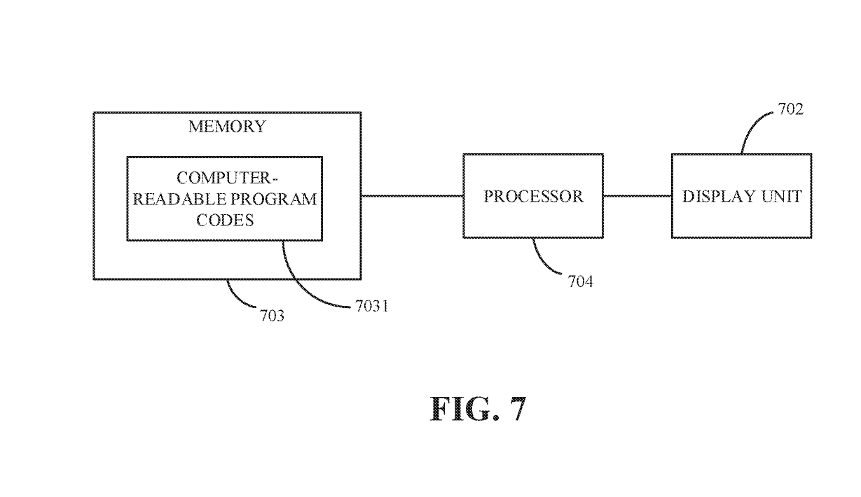

FIG. 7 is a diagrammatic view of a terminal in accordance with an implementation of the present disclosure. The terminal includes a first system and a second system, and can include but not limited to a display unit 702, a memory 703, and a processor 704. The display unit 702 and the memory 703 are electrically coupled to the processor 704.

The display unit 702 is configured to display visual information, such as text, image, for example. The display unit 702 may be a light emitting diode (LED) display screen or an organic light emitting diode (OLED) display screen.

The memory 703 is configured to store a plurality of computer-readable program codes 7031. The memory 703 can be a read only memory (ROM), a random access memory (RAM), a U-disk, a removable hard disk, etc.

The processor 704 can include multiple cores for multi-thread or parallel processing. In this implementation, the processor 704 is configured to execute the plurality of computer-readable program codes 7031 to perform following operations: acquiring information of an initiator of communication information when the communication information is received; and processing the communication information in the first system or the second system according to attribute information of the information of the initiator.

In an implementation, processing the communication information in the first system or the second system according to the attribute information of the information of the initiator includes: determining whether an address book of the terminal includes the information of the initiator; and processing the communication information in the first system when it is determined that the address book of the terminal does not include the information of the initiator.

In an implementation, the plurality of computer-readable program codes 7031 are further executed by the processor 704 to process the communication information in the second system when it is determined that the address book of the terminal includes the information of the initiator.

In an implementation, processing the communication information in the first system or the second system according to the attribute information of the information of the initiator includes: determining a system related to the information of the initiator according to the attribute information of the information of the initiator; processing the communication information in the first system when it is determined that the system related to the information of the initiator is the first system, or when it is determined that the information of the initiator is not related to any system; and processing the communication information in the second system when it is determined that the system related to the information of the initiator is the second system.

In an implementation, the plurality of computer-readable program codes 7031 are further executed by the processor 704 to process the communication information directly when it is determined that the communication information is to be processed in the first system, and encrypt the communication information when it is determined that the communication information is to be processed in the second system, so as to avoid leakage of the communication information.

In the present disclosure, a machine-readable storage medium is further provided. The storage medium includes a plurality of computer readable program codes. The plurality of computer readable program codes are run in a terminal including first system and a second system to execute the processing method for communication information of a terminal described above, which will not be specifically described to avoid repetition.

For those skilled in the art, what needs to be understood is that in the present disclosure, the dual-system terminal is taken as an example to illustrate the processing scheme for communication information. Terminals having three or more systems can adopt the technical solution of the present disclosure to process communication information. That is, each system can adopt a corresponding process method for communication information. For example, for the dual-system terminal, the communication information can be directly processed in the normal system, or can be encrypted in the safety system.

The above specifically illustrates the technical solution of the present disclosure. In the present disclosure, a new processing method for communication information of a terminal is provided. On one hand, a user can independently set a system for processing communication information, thus operation experience of the user can be improved. On the other hand, communication information from important contacts can be set to be processed in the safe system, which can avoid leakage of the communication information from the important contacts, and can effectively ensure safety of the communication information from the important contacts.

The foregoing descriptions are merely preferred implementations of the present disclosure, but are not intended to limit the present disclosure. For those skilled in the art, various changes and variations can be made according to the present disclosure. Any modifications, equivalent replacements, and improvements within the spirit and principle of the technical solution should fall within the protection scope of the present disclosure.

What is claimed is:

1. A method for processing communication information of a terminal comprising a first system and a second system, comprising:
acquiring information of an initiator of communication information when the communication information is received; and
processing the communication information in the first system or the second system according to attribute information of the information of the initiator.

2. The method of claim 1, wherein processing the communication information in the first system or the second system according to the attribute information of the information of the initiator comprises:
determining whether an address book of the terminal comprises the information of the initiator; and
processing the communication information in the first system when it is determined that the address book of the terminal does not comprise the information of the initiator.

3. The method of claim 2, further comprising:
processing the communication information in the second system when it is determined that the address book of the terminal comprises the information of the initiator.

4. The method of claim 3, further comprising:
processing the communication information directly when it is determined that the communication information is to be processed in the first system; and
encrypting the communication information when it is determined that the communication information is to be processed in the second system to avoid leakage of the communication information.

5. The method of claim 2, further comprising:
processing the communication information directly when it is determined that the communication information is to be processed in the first system; and
encrypting the communication information when it is determined that the communication information is to be processed in the second system to avoid leakage of the communication information.

6. The method of claim 1, wherein processing the communication information in the first system or the second system according to the attribute information of the information of the initiator comprises:
determining a system related to the information of the initiator according to the attribute information of the information of the initiator;
processing the communication information in the first system when it is determined that the system related to the information of the initiator is the first system, or when it is determined that the information of the initiator is not related to any system; and
processing the communication information in the second system when it is determined that the system related to the information of the initiator is the second system.

7. The method of claim 1, further comprising:
processing the communication information directly when it is determined that the communication information is to be processed in the first system; and
encrypting the communication information when it is determined that the communication information is to be processed in the second system to avoid leakage of the communication information.

8. A terminal comprising a first system and a second system, further comprising:
a memory storing a plurality of computer-readable program codes; and
a processor configured to execute the plurality of computer-readable program codes to:
receive communication information;
acquire information of an initiator of the communication information when the communication information is received; and
process the communication information in the first system or the second system according to attribute information of the information of the initiator.

9. The terminal of claim 8, wherein the plurality of program codes to process the communication information in the first system or the second system according to the attribute information of the information of the initiator further comprises program codes to:
determine whether an address book of the terminal comprises the information of the initiator; and
process the communication information in the first system when it is determined that the address book of the terminal does not comprise the information of the initiator.

10. The terminal of claim 9, wherein the plurality of computer-readable program codes is further executed by the processor to:
process the communication information in the second system when it is determined that the address book of the terminal comprises the information of the initiator.

11. The terminal of claim 10, wherein the plurality of computer-readable program codes is further executed by the processor to:
process the communication information directly when it is determined that the communication information is to be processed in the first system; and
encrypt the communication information when it is determined that the communication information is to be processed in the second system to avoid leakage of the communication information.

12. The terminal of claim 9, wherein the plurality of computer-readable program codes is further executed by the processor to:
process the communication information directly when it is determined that the communication information is to be processed in the first system; and
encrypt the communication information when it is determined that the communication information is to be processed in the second system to avoid leakage of the communication information.

13. The terminal of claim 8, wherein the plurality of program codes to process the communication information in the first system or the second system according to the attribute information of the information of the initiator further comprises program codes to:
determine a system related to the information of the initiator according to the attribute information of the information of the initiator; and
process the communication information in the first system when it is determined that the system related to the information of the initiator is the first system, or that the information of the initiator is not related to any system, and processing the communication information in the second system when it is determined that the system related to the information of the initiator is the second system.

14. The terminal of claim 8, wherein the plurality of computer-readable program codes is further executed by the processor to:
process the communication information directly when it is determined that the communication information is to be processed in the first system; and
encrypt the communication information when it is determined that the communication information is to be processed in the second system to avoid leakage of the communication information.

15. A non-transitory machine-readable storage medium storing a plurality of computer-readable program codes, the plurality of computer-readable program codes being invoked by a terminal comprising a first system and a second system to:
receive communication information;
acquire information of an initiator of the communication information when the communication information is received; and
process the communication information in the first system or the second system according to attribute information of the information of the initiator.

16. The non-transitory machine-readable storage medium of claim 15, wherein the plurality of program codes to process the communication information in the first system or the second system according to the attribute information of the information of the initiator further comprises program codes to:
determine whether an address book of the terminal comprises the information of the initiator; and
process the communication information in the first system when it is determined that the address book of the terminal does not comprise the information of the initiator.

17. The non-transitory machine-readable storage medium of claim 16, wherein the plurality of computer-readable program codes is further executed by the terminal to:
process the communication information in the second system when it is determined that the address book of the terminal comprises the information of the initiator.

18. The non-transitory machine-readable storage medium of claim 16, wherein the plurality of computer-readable program codes is further executed by the terminal to:
process the communication information directly when it is determined that the communication information is to be processed in the first system; and
encrypt the communication information when it is determined that the communication information is to be processed in the second system to avoid leakage of the communication information.

19. The non-transitory machine-readable storage medium of claim 15, wherein the plurality of program codes to process the communication information in the first system or the second system according to the attribute information of the information of the initiator further comprises program codes to:
determine a system related to the information of the initiator according to the attribute information of the information of the initiator; and
process the communication information in the first system when it is determined that the system related to the information of the initiator is the first system, or that the information of the initiator is not related to any system, and processing the communication information in the second system when it is determined that the system related to the information of the initiator is the second system.

20. The non-transitory machine-readable storage medium of claim 15, wherein the plurality of computer-readable program codes is further executed by the terminal to:
process the communication information directly when it is determined that the communication information is to be processed in the first system; and
encrypt the communication information when it is determined that the communication information is to be processed in the second system to avoid leakage of the communication information.
